(19) United States
(12) Patent Application Publication
(10) Pub. No.: US 2012/0228858 A1
(43) Pub. Date: Sep. 13, 2012

(54) FENDER WITH DRAINAGE FOR BICYCLE

(76) Inventors: Chin-Long Hsieh, Taichung City (TW); Hai-Huan Chiang, Taoyuan County (TW)

(21) Appl. No.: 13/041,475

(22) Filed: Mar. 7, 2011

(51) Int. Cl. B62D 25/18

(52) U.S. Cl. 280/852

(57) ABSTRACT

The fender is formed with a plurality of Y-shaped protrusions on the side facing the wheel. The Y-shaped protrusions are longitudinally arranged in a row. Each of the Y-shaped protrusions is composed of a vee and a vertical. The vee opens towards the direction of forward rotation of the wheel. The water thrown by the wheel will be guided by the verticals of the Y-shaped protrusions first, and then split by the vee to obliquely flow out of the fender.

### BACKGROUND OF THE INVENTION

1. Technical Field

The invention relates to bicycles, particularly to fenders used for bicycles.

2. Related Art

In recent years, cycling is very popular all over the world. Besides transportation and sport, bicycles have a new purpose, for pleasure. These three purposes make cycling people constantly increase.

For the sake of light weight, sports bicycles, such as road bikes and mountain bikes, do not install fenders. During a competition or exercise, expectable or unexpectable rain may come down unavoidably. The rainwater and dirt on the roads will be thrown out onto the cyclists by the rotating wheels when cycling in a rain. Furthermore, the rainwater and dirt on the cyclists will flow along the body and down to the external genitalia and anus. This will invite a potential health problem.

Even if a bicycle is installed with a fender, a traditional fender is an arced smooth sheet without any drainage. The water thrown by wheels will indirectionally scatter after it has been blockaded by the fenders when moving. The aimlessly scattered water possibly flies onto legs of the cyclists.

### SUMMARY OF THE INVENTION

An object of the invention is to provide a fender for a bicycle, which is disposed with drainage protrusions for rapidly and orientedly guiding out a large amount of rainwater. This can increase the effect of blocking water of fenders.

To accomplish the above object, the fender of the invention is formed with a plurality of Y-shaped protrusions on the side facing the wheel. The Y-shaped protrusions are longitudinally arranged in a row. Each of the Y-shaped protrusions is composed of a vee and a vertical. The vee opens towards the direction of forward rotation of the wheel. The water thrown by the wheel will be guided by the verticals of the Y-shaped protrusions first, and then split by the vee to obliquely flow out of the fender.

### BRIEF DESCRIPTION OF THE DRAWINGS

FIG. 1 is a side view showing a bicycle with the fender of the invention;

FIG. 2 is a schematic view depicting the fender of the invention installed on a rear wheel of a bicycle;

FIG. 3 is a perspective view of the invention; and

FIG. 4 is a schematic view showing the water flow guided by the invention.

### DETAILED DESCRIPTION OF THE INVENTION

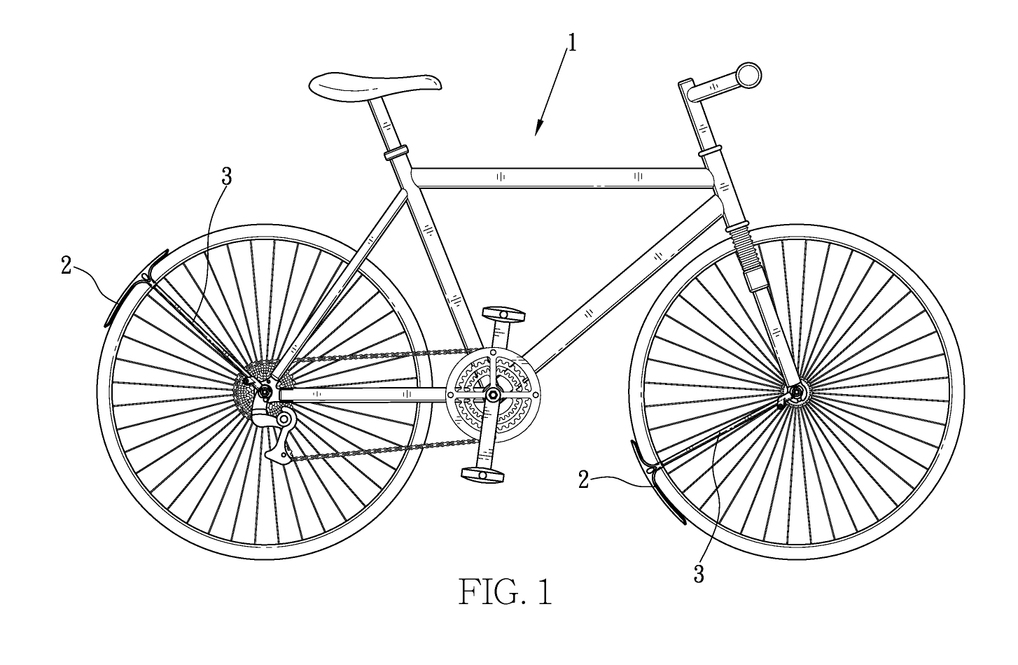

Please refer to FIG. 1, which is a side view of a bicycle 1 with the fender 2 of the invention. The fender 2 adopts a light weight design, i.e. it is about 20-30 centimeters in length and supported by a rod 3 fastened at the wheelshaft. For the sake of light weight, the shortened length of the fender blockades only the water which would be directly thrown onto the cyclist.

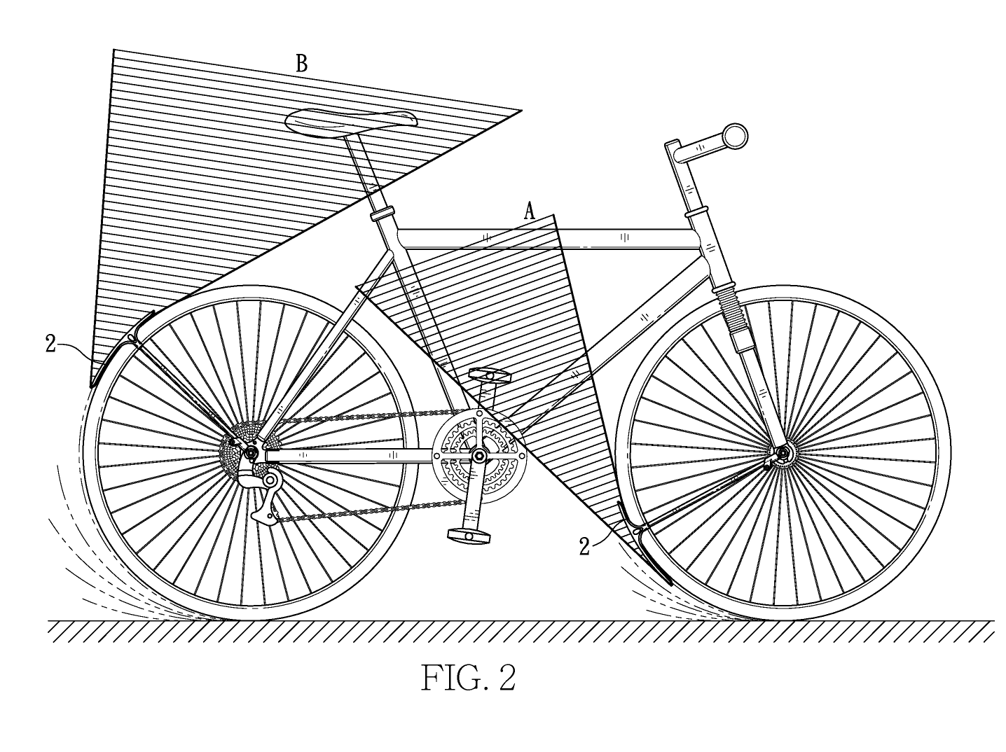

FIG. 2 is a schematic view depicting the fender of the invention installed on a rear wheel of a bicycle. As shown, the fender 2 just covers a section of a wheel which could throw water to a cyclist, i.e. the regions A and B in FIG. 2. The fender 2 does perform a specific effect of water blockading. Region A or B is defined by two tangents to the wheel at the two points at which two ends of the fender 2 are located. Region A and B can prevent water from being thrown to the front and rear of the cyclist, respectively.

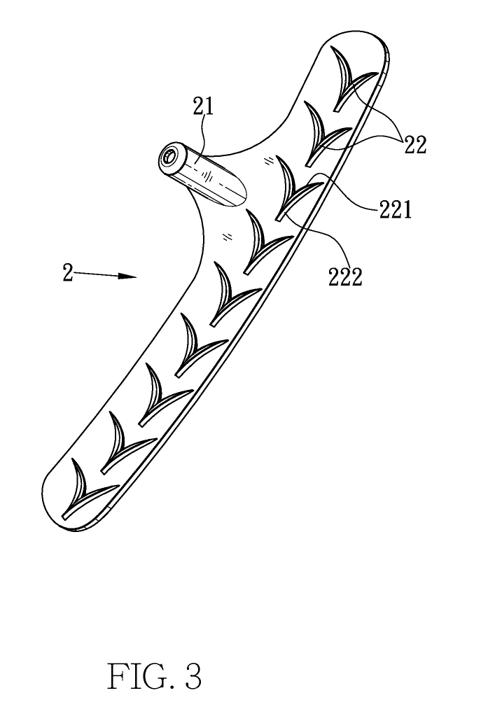

Please refer to FIG. 3. The inside of the fender 2, which is the side facing the wheel, is formed with a fixing seat 21 for connecting the rod 3. The inside of the fender 2 is formed with a plurality of Y-shaped protrusions 22, which are longitudinally arranged in a row along a central line. Each of the Y-shaped protrusions 22 is composed of a vee 221 and a vertical 222. An opening of the vee 221 is towards the direction of forward rotation of the wheel. That is to say, all the Y-shaped protrusions 22 are arranged in the same direction and do not reach the edges of the fender 2.

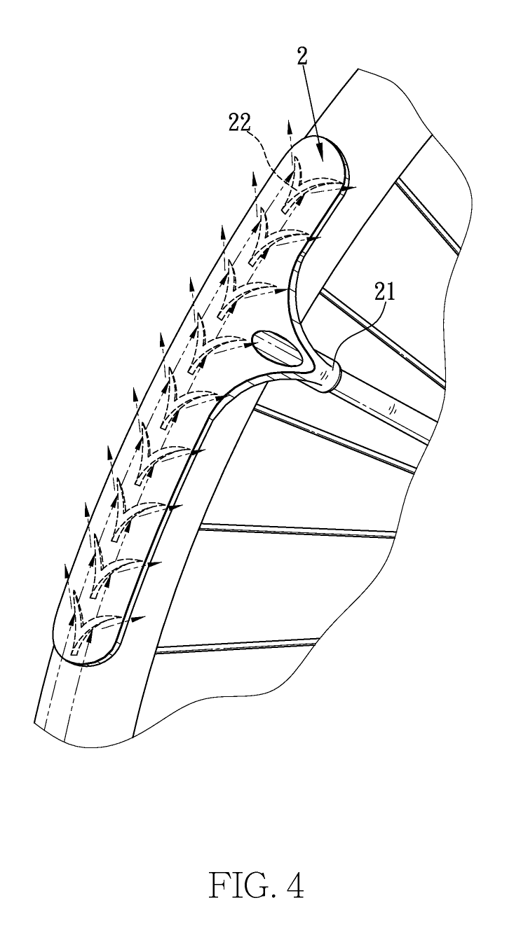

Please refer to FIG. 4. The water attached on a wheel is thrown out along a tangent to the wheel, and the water still has forward moving inertia after it has been thrown out. When the fender 2 with Y-shaped protrusions 22 is installed to a bicycle, the water thrown by the wheel will impact the inside of the fender 2 first, then be guided by the vertical bars 222 of the Y-shaped protrusions 22, and finally be split by the vee 221 to obliquely flow out of the fender 2. As a result, the water can be rapidly drained out without indirectional splashes.

While the forgoing is directed to an embodiment of the present invention, other and further embodiments of the invention may be devised without departing from the basic scope thereof. As such, the appropriate scope of the invention is to be determined according to the claims.

What is claimed is:

1. A fender for a bicycle, the fender having an inside facing a wheel of the bicycle, the fender comprising:
a fixing seat for connecting a rod;
a plurality of Y-shaped protrusions, formed on the inside, longitudinally arranged in a row, wherein each of the Y-shaped protrusions is composed of a vee and a vertical bar, and the vee opens towards a direction of forward rotation of the wheel.

2. The fender of claim 1, wherein each of the Y-shaped protrusions does not reach edges of the fender.

3. The fender of claim 1, wherein the Y-shaped protrusions are arranged along an identical central line.
